(19) United States
(12) Patent Application Publication
(10) Pub. No.: US 2011/0031896 A1
(43) Pub. Date: Feb. 10, 2011

(54) LIGHTING DEVICE FOR LIGHTING THE AIRFIELD OF AN AIRPORT

(76) Inventors: Jean-Claude Vandevoorde, Steenkokkerzeel (BE); Andre Jelu, Hoegaarden (BE); Francoise Van Buylaere, Brussels (BE); Maarten Willekens, Mechelen (BE)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/682,486

(22) PCT Filed: Oct. 8, 2008
(86) PCT No.: PCT/EP08/63452

§ 371 Date: Oct. 12, 2010

(30) Foreign Application Priority Data
Oct. 9, 2007 (DE) 10 2007 048 492.7

(51) Int. Cl. H05B 37/02

(52) U.S. Cl. 315/294

(57) ABSTRACT

The invention relates to a lighting device (1) for lighting the airfield of an airport, comprising a plurality of lighting units (2) for emitting light signals for an approaching, departing, or rolling aircraft, a power supply system which is used for supplying electric power to the lighting units (2) and is equipped with at least one control unit (4) for adjusting a constant current or a constant voltage in a circuit (3) encompassing at least one of the lighting units (2), and configuration data (k) for configuring the at least one control unit (4) in the circuit (3). In order to allow a control unit (4) that has to be replaced to be quickly and safely replaced, the lighting device (1) comprises a memory unit (5) for storing configuration data (k) and a communication unit (6) for transmitting data between the at least one control unit (4) and the memory unit (5). The communication unit (6) is designed to automatically retrieve configuration data (k) stored in the memory unit (5) and feed said configuration data (k) to the at least one control unit (4) when the at least one control unit (4) is started.

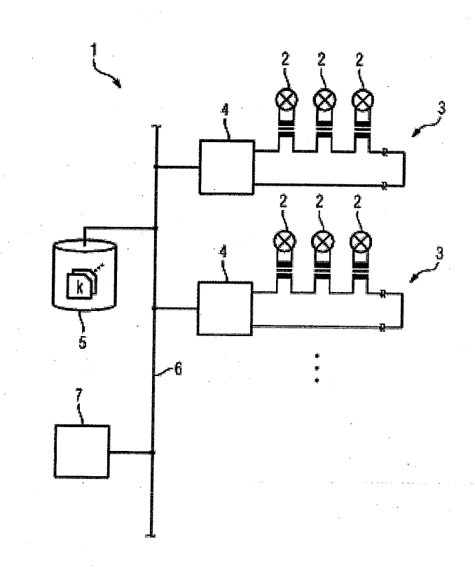

The invention relates to a lighting device for lighting the airfield of an airport, comprising a plurality of lighting units for emitting light signals for an approaching, departing or taxiing airplane, having an energy supply unit for supplying the lighting units with electric energy, which comprises at least one regulator for setting a constant current or a constant voltage in a circuit having at least one of the lighting units, and having configuration data for the configuration of the at least one regulator in the circuit.

For the orientation and guiding of airplanes that are in the process of landing at an airport, or moving on the take-off, landing, or taxi strips, light signals are emitted by lighting units of the airfield lighting. Lighting devices comprise any light-technical aids ensuring safe air traffic and safe taxiing of airplanes within the region of an airport, even in bad visibility conditions, particularly in darkness. For this purpose, approach lights, angle of descent lights, threshold lights, lateral and center row lights, take-off and landing strip lights, runway lights, identification lights, hazard lights, obstacle lights, and revolving lights, among others, are differentiated.

In order to avoid any confusion of a pilot due to light signals having a fluctuating brightness, a constant energy supply of the lighting units connected in a circuit is required. In lighting units that are series-connected to a circuit the supply with constant electric energy is ensured as a regulator configured as a constant current regulator. The constant current regulator supplies a constant rated output current under varying conditions, such as fluctuations of the power input voltage or frequency, the ambient temperature, the sea level of the location, the relative humidity, or of the payload applied.

A constant current regulator for supplying series-connected current circuits in airport lighting systems, having different brightness levels, is known from the DE product booklet “Konstantstromregler Mikroprozessor-gesteuert: A.06.350d,” order No. E10001-T95-A520V2, published in 1995 by Siemens AG. The constant current regulator has a power module comprising anti-parallel connected thyristors, a high-voltage part with output transformer, and a control module, which controls the supply voltage of the output transformer via thyristors. For this purpose the control module determines a thyristor firing angle, by means of which the output current is adjusted to a rated value, the size of which in turn depends on the selected level of brightness.

A further constant current regulator is known from the product booklet “Microprocessor controlled Constant Current Regulator: Type MCR³,” A.07.360e, published by NV. ADB S.A., A Siemens Company, order No. 1000001-T95-A129-V1-7600.

However, other units exist in addition to constant current regulators, such as voltage regulators or master units for so-called ILCM illumination controllers—wherein ILCM stands for individual lighting control & monitoring—which are used for regulating brightness and actuating current circuits of the airfield lighting at an airport. Due to the different functions of the brightness regulated or actuated current circuits specific configuration data is relevant for said current circuits and for the controllers thereof. Such configuration data is generated during the construction or the installation of the circuits, and the respective constant current regulator is supplied with the same.

If any defect or any other error occurs, a replacement constant current regulator must be inserted in the place of the defective constant current regulator during operation. For this purpose the replacement constant current regulator must be configured quickly and correctly, which may lead to unacceptable errors or omissions during the existing work pressures. Said problem is all the more significant since due to the large number of constant current regulators and due to the circuits supplied by the same, the defect or maintenance related exchange of defective constant current regulators must be carried out at increasing frequency.

The invention is therefore based on the object of providing a lighting device of the type mentioned above, wherein a quicker and more error-free use of regulators to be replaced is enabled.

The problem is solved according to the invention by means of a generic lighting device having the features of the characterising part of claim 1. Accordingly, the lighting device is characterized by a memory unit for storing configuration data and by a communication unit for data transfer between the at least one regulator and the memory unit. For this purpose the communication unit is configured such that, upon putting into service the at least one regulator, the communication unit automatically retrieves configuration data stored in the memory unit and feeds it to the at least one regulator. By so doing, if for example after a defect of the regulator a new regulator is connected to the power supply system and to the communication unit as replacement for the same, the communication unit determines the identity of the replaced regulator and queries the central memory unit, whether configuration data is stored for said regulator. In a positive case said configuration data is retrieved by the memory unit and automatically transferred to the replaced regulator for the supply of the same. Due to the automatic supply of the replaced regulator with the configuration data centrally stored and provided for the same by the communication unit, a quick and error-free exchange of a defective regulator is enabled via a new regulator.

In a preferred embodiment of the lighting device according to the invention, the communication unit is further configured such that it automatically feeds already supplied configuration data to the memory unit when a regulator is put into service. In this manner it is achieved that a complete set of files comprising configuration data for all regulators of the lighting device is available in the memory unit. When the regulators are put into service for the first time, they are typically supplied with configuration data intended for them already before startup. If such a regulator is started up in the lighting device, the communication unit automatically retrieves the configuration data of said regulator, and transfers it to the central memory unit in order to deposit it there.

In an advantageous embodiment of the lighting device according to the invention, the same comprises at least one controller for actuating and monitoring the at least one lighting unit in the circuit, wherein the configuration data comprises information on the levels of brightness adjustment and/or on error modes and/or on switch-on modes and/or on the designation of interface levels within the circuit. Through the controller, which may be operated, for example, by traffic control personnel in the control tower of the airport, or by maintenance personnel, the lighting units can be switched on or off, the brightness thereof can be adjusted, errors in the lighting units can be reported to the traffic control personnel, and the interface level thereof can be designated within the circuit. All of this information is contained in the configuration data of the respective regulator and, according to the invention, can be stored in the central memory unit for later use.

In an advantageous embodiment of the lighting device according to the invention, the communication unit is configured for the wired and/or wireless, bidirectional data transfer between the at least one controller, the at least one regulator, and the memory unit. The bidirectional data traffic between the memory unit and the regulators enables the transfer of configuration data into both directions. For this purpose, field buses may be used, such as the J-bus, Profibus and the like, an Ethernet, the Internet and optical connections or radio connections, such as a local wireless network (WLAN).

Preferably, the communication unit of the lighting device according to the invention is configured in a redundant manner. In this manner the communication may occur, for example, wire-bound via the energy supply lines of the regulators, and additionally via a wireless network operating in parallel, or in case of failure of the so-called power line communication.

In a preferred embodiment of the lighting device according to the invention, at least two regulators are combined into a regulator group, with which a replacement regulator is associated, which is provided for being put into service in case of failure of a regulator of the regulator group, wherein configuration data for the replacement regulator, which is retrievable by the communication unit, is stored in the memory unit. In this manner the replacement device of each regulator group may simply be switched on as soon as one of the regulators of this regulator group becomes defective.

In a further preferred embodiment of the lighting device according to the invention, the regulator is configured as a constant current source for lighting units connected to a series circuit. In case of lighting units connected in series the regulator must supply a constant current to all lighting units such that no brightness fluctuations occur between the lighting units, which could confuse a pilot.

As an alternative, the regulator of the lighting device according to the invention is configured as a constant voltage source for lighting units connected to a parallel circuit. With a parallel circuit of the lighting units the regulator accordingly must supply a constant voltage for all lighting units such that all lighting units are illuminated at the same brightness.

Further properties and advantages of the lighting device according to the invention are obvious from the following description of the drawing, the only FIGURE of which shows a circuit diagram of the lighting device.

According to the only FIGURE, a lighting device 1 according to the invention for lighting of the airfield of an airport comprises a plurality of lighting units 2, which are series-connected in a series circuit 3. The interconnection of lighting units into a parallel circuit is also possible, although not illustrated. The lighting units 2 of a circuit 3 may be, for example, threshold lights, lateral or center row lights, or also runway lights having allogen lamps or light emitting diodes as illumination means, such as in a sub-floor type of construction, and are generally known. A series circuit 3 is supplied with electric energy by means of a regulator 4 that is configured as a constant current regulator.

Such constant current regulators 4 are generally known, wherein the interfaces and operating specifications thereof are specified by international standards, such as the IEC 61822 “Electrical installations for lighting and beaconing of aerodromes—Constant current regulators” (International Electrotechnical Commission), or other regional standards, such as the FAA Advisory Circular 150/5345-10 (Federal Aviation Association).

For operating and monitoring the lighting units 2 by the air traffic control personnel of the airport air traffic control tower or by the maintenance personnel, a controller 7 is provided, which is connected to the regulators 4 via a communication unit 6. The regulators 4 may be connected to the circuit either separately, or via a two-wire line 6, which is configured as a bidirectional field bus for the data transmission between the controller 7 and the regulators 4. This means that in this so-called power line communication both data and electric energy are transferred via the same lines 6. This enables a very large data transfer rate for data communication.

If any defect or any other error occurs in one of the regulators 4, the same must be replaced by a new regulator 4. In order to startup the new regulator 4, not only the current input and output must be connected, but the new regulator 4 must also be correctly configured within the circuit 3 to be supplied. This includes, among others, the supply of the regulator 4 with information on the levels of the brightness adjustment or current intensity, via error modes, via on and off switching modes, via the designation of the interface level of the circuits, and via related functions and the like.

According to the invention, the lighting device 1 comprises a memory unit 5 for this purpose, which is connected to the controller 7 and to the regulators 4 via the communication unit 6. Configuration data k is stored in the memory unit 5 for each of the regulators 4 of the lighting device 1. The communication unit 6 is configured such that upon connecting a new regulator 4 to the communication unit 6 a query is initially started as to whether a configuration file is supplied with configuration data k, or is active in the new regulator 4. For this purpose an identification number or address is associated with each regulator 4 in the communication network 6. If the new regulator 4 is not yet supplied with configuration data k, the configuration data k is queried in the memory unit 5 using the respective identification number and transferred to the new regulator 4. In this manner it is ensured that with the connection of a new regulator the correct configuration data k is transferred for supplying the new regulator 4. An exchange of the defective regulator with a new regulator 4 is therefore possible in a quick and error-free manner.

The data base of configuration data k provided in the memory unit 5 may be established manually or also automatically when connecting a new regulator 4. If the lighting device 1 is supplemented by an additional regulator 4, which is already well supplied with configuration data k, the communication unit 6 determines upon the connection of said regulator 4 that configuration data k is already supplied. In this case said configuration data k is transferred to the memory unit 5 via the communication network 6 using the respective identification number, and deposited at that location.

In addition to said line-bound field bus, the communication unit 6 may additionally or alternatively have a secured wireless communication connection, such as a WLAN (wireless local area network). Due to this redundant embodiment the lighting device 1 according to the invention is more secure with regard to the data transfer. Furthermore, the exchange of lighting units 2 or regulators 4 is possible without any confusion of the controllers 7, or of the communication unit 6, wherein the current input and the series circuit output of the regulator 4 are further simple to standardize. It is further possible to incorporate the regulators 4 in the data network 6 via the coordinates or addresses thereof, and to store the same, and to retrieve and download the respective configuration file k, if a new regulator 4 is switched on as the replacement.

The invention can also be applied to other combinations of controllers and regulators for regulating brightness, and for actuating circuits of airfield lighting in an expandable manner. In addition to the constant current regulators and the constant voltage sources, the same is particularly suitable for master units of so-called ILCM illumination controls, wherein ILCM stands for individual lighting control & monitoring. In any case the manual reconfiguration of individual regulators, particularly also in emergency situation under time pressure, is avoided, thus representing a significant contribution to air traffic safety.

1. A lighting device for lighting the airfield of an airport, comprising a plurality of lighting units for emitting light signals for an approaching, departing or taxiing airplane, having an energy supply unit for supplying the lighting units with electric energy, the lighting device comprising at least one regulator for setting a constant current or a constant voltage in a circuit comprising at least one of the lighting units, and comprising configuration data for the configuration of the at least one regulator in the circuit, wherein the lighting device comprises a memory unit for storing configuration data, and a communication unit for data transfer between the at least one regulator and the memory unit, wherein the communication unit is configured such that, when the at least one regulator is put into service, it automatically retrieves configuration data stored in the memory unit, and feeds it to the at least one regulator.

2. The lighting device according to claim 1, wherein the communication unit is further configured such that, when a regulator is put into service, it automatically feeds already supplied configuration data to the memory unit.

3. The lighting device according to claim 1, comprising at least one controller for actuating and monitoring the at least one lighting unit in the circuit, wherein the configuration data comprises information on the levels of brightness adjustment and/or of error modes and/or of switching on modes and/or of designation of the interface levels in the circuit.

4. The lighting device according to claim 1, wherein the communication unit is configured for the wired and/or wireless, bidirectional data transfer between the at least one controller, the at least one regulator, and the memory unit.

5. The lighting device according to claim 1, wherein the communication unit is configured in a redundant manner.

6. The lighting device according to claim 1, wherein at least two regulators are combined to one regulator group, with which a replacement regulator is associated that is provided for being put into service in case of failure of a regulator of the regulator group, wherein configuration data for the replacement regulator, which is retrievable by the communication unit, is deposited in the memory unit.

7. The lighting device according to claim 1, wherein the regulator is configured as a constant current source for lighting units connected to a series circuit.

8. The lighting device according to claim 1, wherein the regulator is configured as a constant voltage source for lighting units connected to a parallel circuit.
